(19) United States
(12) Patent Application Publication
(10) Pub. No.: US 2015/0161594 A1
(43) Pub. Date: Jun. 11, 2015

(54) PAYMENT UNIT, SYSTEM AND METHOD

(71) Applicant: VANCLARE SE LLC, New York, NY (US)

(72) Inventors: Christopher Whitland Jarman, Ellesmere Port Cheshire (GB); Nicholas Kim Taylor, Ellesmere Port Cheshire (GB)

(21) Appl. No.: 14/403,536

(22) PCT Filed: May 24, 2013
(86) PCT No.: PCT/GB2013/051374

§ 371 Date: Nov. 24, 2014

(30) Foreign Application Priority Data
May 25, 2012 (GB) 1209232.6

(51) Int. Cl. G06Q 20/34

(52) U.S. Cl. CPC G06Q 20/352

(57) ABSTRACT

A payment unit, method and system are disclosed. In one arrangement, the payment unit includes a payment card reader to participate in a payment communication to obtain payment data, a secondary reader to obtain supplementary data from a machine readable entity that is physically proximate to the unit, the supplementary data being obtained via a communication that is separate from the payment communication, and a controller to operate the payment card reader and secondary reader and to generate a payment record from said payment data and said supplementary data.

### FIELD OF THE INVENTION

The present invention relates to a payment unit, system and method of processing card payments.

### BACKGROUND TO THE INVENTION

Security of payment transactions is always a major issue irrespective of the method of processing the payment. If there is a possibility of fraud, it can be expected that this possibility will at some point be identified and exploited.

Of course, security must always be balanced with convenience. While many users appreciate that the most convenient payment methods often pose a security risk, some users are ignorant of those risks and even those that are aware of the risk many chose to pick convenience over security. The more hurdles and checks that are placed in the way, the more likely it is that a user will select a less secure alternative method of progressing his or her transaction.

One method of making payments that is increasing in popularity is that of contactless payment. Contactless payment systems typically use Radio-Frequency ID (RFID) type technologies to enable a credit card or similar unit to make a payment. As RFID is used (as opposed to chip and PIN or magnetic stripe reading of the card), no contact is needed between the chip holding the data and the terminal reading the chip and it is therefore termed “contactless”. However, it should be noted that while it is not strictly necessary in practice a user will often touch the card or unit to the terminal during the communication. This is still a contactless transaction in the sense that physical contact between the chip and terminal is not needed for communication

One form of contactless communication is known as near field communications (NFC). Near field communication refers to a communication standard that is being increasingly incorporated into smartphones and similar devices. Two NFC enabled devices can communicate via radio frequencies when in close proximity, usually no more than a few centimetres and normally touching together. Example NFC implementations that have been applied to card payment systems include the Google® Wallet function that is integrated into recent Google Android® smart phones. Credit cards can be registered with the Wallet and the smart phone can then be used in place of the credit card to pay for purchases.

There have been numerous reports and proofs of concept that RFID and NFC payment mechanisms are vulnerable to attacks such as eavesdropping, man-in-the-middle and relay attacks. As a result, some service providers have imposed low caps on the amount a contactless payment unit or NFC device can be used to pay for in any one transaction.

Although convenient to use, contactless and NFC payment mechanisms risk being considered too vulnerable to be a replacement or competitor to chip and PIN based credit cards and the like.

### STATEMENT OF THE INVENTION

According to an aspect of the present invention, there is provided a card payment unit including a payment card reader, a secondary reader and a controller, the controller being configured to operate the payment card reader to participate in a payment communication to obtain payment data, the controller being further configured to operate the secondary reader to obtain supplementary data from a machine readable entity that is physically proximate to the terminal, the supplementary data being obtained via a communication that is separate from the payment communication, the controller being configured to generate a payment record from said payment data and said supplementary data.

The secondary reader is preferably a Radio Frequency data reader such as an RFID reader. The payment card reader and secondary reader may be the same device operated in different modes, a first mode configured to obtain payment data from a payment card and the second mode configured to obtain the supplementary data. The payment card reader may be a contact based card reader such as a chip and PIN reader, or a contactless reader such as an RFID type or NFC type reader. The secondary reader may include an RFID type reader configured to obtain data from the machine readable entity via an RFID communication. The obtained data may be used as, or used to form, at least a part of the supplementary data. The machine readable entity may be a machine readable travel document (MRTD) and may preferably be an electronic MRTD (e-MTRD) compatible entity.

The payment terminal may include an input device configured to receive authentication data on the machine readable entity. The input device may be a keyboard, keypad, camera, barcode reader, optical character recognition (OCR) device or other input device. The controller may be optionally configured to receive the authentication data and obtain the supplementary data in dependence on the authentication data. In a preferred embodiment, the machine readable entity includes encoded data, the encoded data being decodable using authentication data, both the authentication data and the encoded data being machine readable from the machine readable entity. The payment terminal may include an OCR reader configured to read machine readable authentication data from the machine readable entity, the controller being arranged to receive the authentication data from the OCR reader and use the authentication data to access the encoded data using the secondary reader and obtain the supplementary data.

In one embodiment of the present invention, a contactless payment terminal includes a radio frequency transceiver and a controller, the controller being configured to operate the radio frequency transceiver to participate in a payment communication with a contactless payment card to obtain payment data, the controller being further configured to obtain supplementary data in dependence on a communication between the secondary reader and a machine readable entity that is physically proximate to the terminal, the communication being separate from the payment communication, the controller being configured to generate a payment record from said payment data and said supplementary data.

According to another aspect of the present invention, there is provided an increased security payment system comprising a user payment device and a remote payment processing system, the user payment device including a payment card reader and a radio frequency transceiver and being connectable to a data communications network for communication with the payment processing system, wherein the user payment device is arranged, during a payment made via the payment card reader, to operate the radio frequency transceiver to obtain supplementary data from a machine readable entity that is physically proximate to the user payment device and to communicate data on the payment and on the supplementary data via the data communications network to the payment processing system, the payment processing system being arranged to process the received data and communicate data on the payment to a card payment processing network to cause completion of the payment.

The user payment device may include a memory for encoding authorisation data, the user payment device being arranged to access the authorisation data in the memory for accessing the machine readable entity when obtaining the supplementary data.

The data on the payment may be communicated to the remote payment processing system prior to obtaining supplementary data, the remote payment processing system being arranged to process the payment data and communicate a challenge to the user payment device under predetermined conditions, the user payment device being arranged, in response to receipt of the challenge, to operate the radio frequency transceiver to obtain the supplementary data and to communicate data on the supplementary data to the payment processing system.

The remote payment processing system may be arranged to verify the received data on the supplementary data.

It will be appreciated that the term “contactless payment card” may also include devices having the functionality of a contactless payment card such as an NFC payment device, for example an appropriately configured NFC enabled mobile telephone.

Preferred embodiments of the present invention are directed to a secure contactless payment terminal and associated system in which a contactless payment terminal is arranged to obtain payment data via a contactless communication system such as an NFC communication system and to also obtain supplementary data in a separate communication from a machine readable entity. Preferably, a common radio frequency transceiver is used in the contactless communication system and in obtaining the supplementary data (which may, for example, be data obtained from an electronic Machine Readable Travel Document (e-MRTD) or other officially recognised document). The payment data and supplementary data are then used to form a payment record in which the machine readable entity is used to supplement, secure or otherwise authenticate the NFC payment. For example, the machine readable entity may be a passport or other official document (preferably an electronic Machine Readable Travel Document or e-MRTD).

Although it is preferred that the contactless payment unit (such as an NFC enabled device) is separate to the machine readable entity, embodiments of the present invention are possible in which they are different functions incorporated into the same device/entity.

In embodiments of the present invention, contactless reader function of a payment terminal is used and extended to allow the identification of an e-MRTD and to perform data capture from the e-MRTD. In alternate embodiments, a combined contactless and contact card payment terminal is used to enable card payments by contactless or contact based (such as chip and PIN) technologies. The contactless reader is also used to acquire supplementary data from an e-MRTD or the like such that contact and e-MTRD or contactless and e-MRTD data can be generated for transaction records. The acquired data can then be subject to secure storage (possibly in a remote server) and consolidation with secure data derived from a payment transaction. This combined data can provide an increased level of assurance to validate not only the payment but also the person making the payment. Capturing data that encapsulates individual characteristics, including a facial photograph and other biometric data, and amalgamating this with payment transaction data can be used to reduce ticket fraud and improve transport safety where a repeat check on all elements of the transaction is made at the point of travel. This would involve rescanning the payment card and e-MRTD in an enhanced terminal at the point of travel and validating these components against secure data records recovered from the original transaction.

The payment record (or selected parts thereof) may be transmitted to a bank or other processing system for effecting payment.

### BRIEF DESCRIPTION OF THE DRAWINGS

Embodiments of the present invention will now be described by way of example only with reference to the accompanying drawings in which:

FIG. 1 is a schematic diagram of a contactless payment terminal according to an embodiment of the present invention;

FIG. 2 is a schematic diagram of a contactless payment terminal according to an embodiment of the present invention;

FIG. 3 is a schematic diagram illustrating handling of data in embodiments of the present invention;

FIGS. 4 and 5 are flow diagrams of the data capture and validation process, respectively; and,

FIG. 6 is a schematic diagram of an increased security payment system according to another embodiment of the present invention.

### DETAILED DESCRIPTION

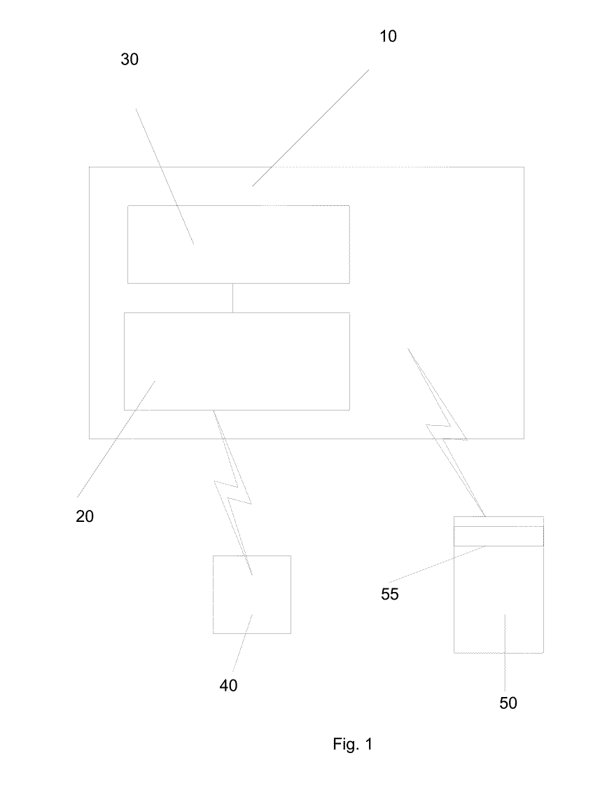

FIG. 1 is a schematic diagram of a contactless payment terminal according to an embodiment of the present invention.

The contactless payment terminal 10 includes a radio frequency transceiver 20 and a controller 30.

During payment for a transaction, the controller is configured to operate the radio frequency transceiver 20 to participate in a payment communication with a contactless payment unit 40 to obtain payment data. The controller is further configured to obtain supplementary data from a machine readable entity 50 that is physically proximate to the terminal 10 in a communication that is separate from the payment communication.

Having obtained the payment data and supplementary data (which it will be appreciated can be obtained in any order or concurrently), the controller 30 is configured to generate a payment record from said payment data and said supplementary data.

The payment data and supplementary data may be combined, encrypted or otherwise processed to form at least part of the payment record. Preferably, the payment record includes data enabling verification of the presence of the machine readable entity 50 proximate to the terminal during at least part of the payment transaction. For example, the payment record may include a hash or cryptographic hash of the supplementary and payment data as well as potentially data such as name, photograph and the like of the bearer of the MRTD. In one embodiment, the payment record may include a data token derived uniquely by a cryptographic hash from the payment data and supplementary data and that which, in itself, does not include any personal private data extracted from the payment unit or machine readable entity.

The machine readable entity 50 may include a data protection system 55. In preferred embodiments, the controller 30 is configured to retrieve supplementary data from the machine readable entity 50 via the data protection system 55.

In one embodiment, the machine readable entity may be a Machine Readable Travel Document (MRTD) document and preferably an electronic MRTD (e-MRTD) document.

Machine Readable Travel Documents (MRTDs) are formed from carrier media that typically carry both printed and machine readable data. MRTD formats and content are set out in International standards established by the International Civil Aviation Organisation (ICAO). One type of MRTD is a Machine Readable Passport (MRP).

One standard covering MRTDs is ICAO standard 9303. An MRTD may contain printed text and picture content that is formatted and positioned in a standard way to allow an optical character recognition (OCR) system to scan and capture the information.

Recently, electronic MRTDs (known as e-MRTDs) have been implemented. An e-MRTD provides enhanced functionality whereby the carrier medium includes an integrated circuit and memory in which the printed contents are duplicated and electronically accessible. The e-MRTD also stores additional data records in electronic form. These electronic data records are readable remotely using contactless technology. So-called “chipped” passports or e-Passports now issued in the UK are an example of electronically enabled passports that are compliant with ICAO standards set out in Doc 9303 Part 1 Volume 2.

Security and privacy of the data stored electronically on the e-MRTD is assured by a data protection system 55 in the form of authorisation and encryption processes. Furthermore, the data protection system 55 can include an authentication method that typically adopts Public Key Infrastructure (PKI) processes to confirm that an e-MRTD is genuine and unaltered. In general, full access to the secure data on an e-MRTD is only possible after first authorisation from the data protection system. Successful access is possible by capture of certain information (referred to here as authorisation data) recorded in a so-called Machine Readable Zone (MRZ) on the e-MRTD and by use of this data to derive the relevant keys to permit decryption of the data stored electronically in the e-MRTD.

The MRZ is a specific physical zone in a predetermined location on the carrier. The capture process is normally performed using an OCR scanner, camera or other image capture device but manual entry is permitted as a fall-back mechanism. The MRZ data can adopt alphabetic, numeric and certain punctuation characters; the “mandatory” MRZ data field contains 44 characters in total. Only a portion of the MRZ data (document number, date of birth and document expiry date—normally covering 24 characters) is required to support derivation of the document basic access keys that grant access to the basic electronic data records.

In support of global interoperability, data is stored electronically on an e-MRTD in a specific format known as a Logical Data Structure (LDS). The LDS is defined in Section 3 of ICAO Document 9303 Part 1 Vol 2 and consists of both mandatory and optional data elements. Four groups of Data Elements are considered to be mandatory: the contents of the MRZ (Data Group 1); an encoded image of the face of the holder (Data Group 2); a group labelled EF.COM (stored in a separate Dedicated File) containing version information and tag list; and a group labelled EF.SOD (stored in a separate Elementary File) containing data integrity and authentication information. Additional optional data groups defined in the LDS contain further data elements, including supplementary biometric characteristics such as fingerprints and eye (iris) patterns. In general, access to the more sensitive personal data is protected by extended access controls or extended encryption techniques.

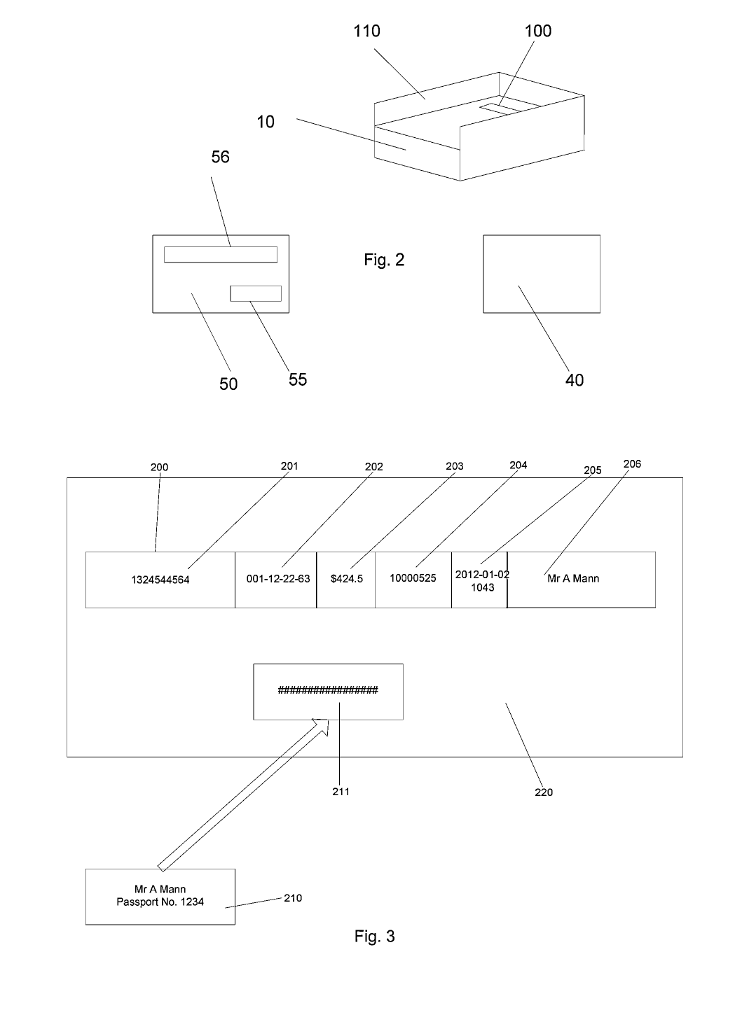

FIG. 2 is a schematic diagram of a contactless payment terminal according to an embodiment of the present invention. Much of the functionality and components of this embodiment are common with that of FIG. 1 and will not be repeated. The terminal 10 includes an optical reader component 100 which is coupled to the controller 30. Optionally, the terminal 10 may include guides 110 as shown.

In use, an e-MRTD is presented to the terminal by lining it up against the optical reader component 100. Where guides 110 are present, these provide visual (and physical, should the guides be in the form of walls or the like) guidance to the user to enable alignment of the e-MRTD 50 with the optical reader component 100. The terminal 10 is arranged such that when the e-MRTD is presented to the reader component, the MRZ 56 of the e-MRTD 50 is readable by the optical reader component 100. The reader component 100 will to some extent be dependent on what it needs to read, although it would typically be an OCR, image sensor or barcode reader. A magnetic stripe reader, chip and PIN or other reader component may be used instead of the optical reader component 100 should the e-MRTD have suitable accessible facilities for retrieval of data using such technologies.

The controller operates the reader component 100 to read the MRZ 56 and obtain the authorisation data. The controller 30 then uses the authorisation data to, where necessary, obtain relevant public keys (these may be held locally in a database or the like may be obtained from a remote source), or otherwise derive (for example by combining with a symmetric cipher) or select access keys, following which the controller 30 retrieves and decrypts at least some of the supplementary LDS data from the e-MRTD using the access keys. The controller 30 may use the radio frequency transceiver 20 to retrieve and decrypt the supplementary data from the e-MRTD or the terminal 10 may include an additional component for this function.

The terminal 100 may also include or be connectable to a manual data entry component (such as a keyboard, camera or other input device) for manual or assisted input of the authorisation data should the machine reading fail.

The contactless data-access technology used in ICAO e-MRTDs complies with the ISO 14443 NB standard which is also a requirement for RFID and NFC systems and a transceiver operable to read one of these items can be reconfigured to also read the other. Therefore a common transceiver is used in preferred embodiments.

It will be appreciated that the terminal would typically also include components such as a radio-frequency antenna and inductive power coupling circuitry that conform to appropriate international standards such as ISO/IEC 14443 Type A and/or ISO/IEC 14443 Type B.

Selected Data Elements that may be involved in an EMV contactless payment transaction are defined in Table A.1 of the EMV® Contactless Specifications for Payment Systems, Book A (Architecture and General Requirements). Additional and proprietary Data Elements can be involved when processing transactions using a particular Kernel and these are defined in the relevant Kernel specifications. A corresponding set of Data Elements that may be involved in an EMV contact (chip and PIN) payment transaction are defined in Annex A of the EMV Integrated Circuit Card Specifications for Payment Systems, Book 3 (Application Specification). Fundamental data elements used in transaction processes are common to both contactless and contact methods. These include so-called Track 1 and Track 2 data that also resides on a card's magnetic stripe including, but not limited to, cardholder name, primary account number (PAN) and card expiry date. Track 1 and Track 2 data also includes discretionary parts that can differ by card type.

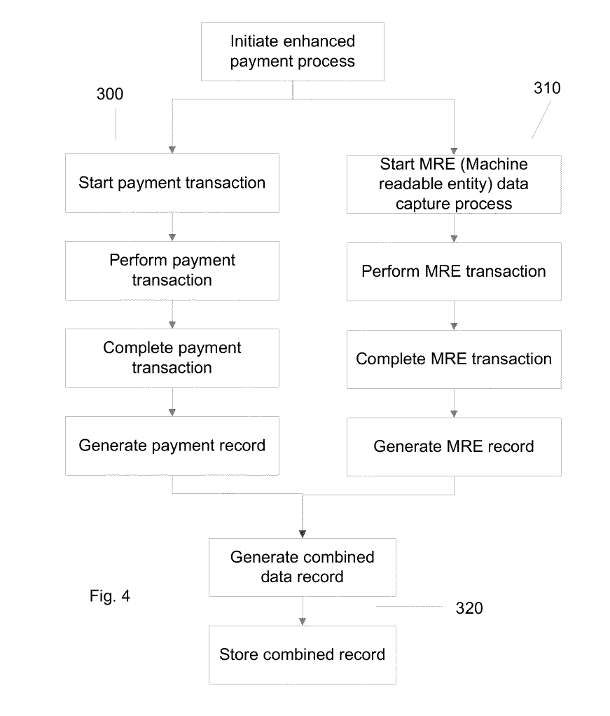

FIG. 3 is a schematic diagram illustrating handling of data in embodiments of the present invention. For ease of explanation only, the data illustrated has been simplified and it will be appreciated that embodiments of the present invention are applicable to varying types of transactions and transaction data of varying lengths and complexities.

A payment communication is undertaken with the payment card reader (either by contact or contactless communication with a payment entity such as a chip and PIN credit card, NFC payment device etc). Upon success of the payment communication, the payment card reader obtains payment data which in this example includes payment entity identifier (eg credit card number) 201, payment amount 203, date and time of payment authorisation by user 205 and cardholder name 206. This data is combined with data from the payment card reader/payment terminal including in this example merchant ID 202 and a merchant unique payment identifier 204 to form the payment data 200.

A secure hash code (such as SHA 256) may be generated based on data stored on the payment card. This secure hash could then be stored instead of the data itself to simplify compliance with data security standards. In the case that the secure hash is stored, in one embodiment the date and time information 205 is not included in the hash (or is included in such a way that the hash can be matched against one produced at a later time/date where the later produced hash has a different date and time).

In a separate communication, the secondary reader obtains supplementary data from a machine readable entity that is physically proximate to the card payment unit. In this example, the secondary card reader is an RFID reader that is configured to obtain data from an e-MRTD entity (Mr A Mann's passport) 210. The supplementary data is in this example hashed using a cryptographic hash function (such as SHA 256) to create a digital fingerprint of the data and the hashed data 211 is combined with the payment data 200 to form the payment record.

A payment record of this type enables supplementary (and preferably authenticable) data to be obtained and combined with payment data to provide greater assurance as to the identity of the purchaser and also for use in subsequent validation of payment.

Repeating the reading of the card and e-MRTD document at a later date enables authentication of the purchaser/purchasing card. The repeated reading can be used to re-create a hash that can be compared to that originally generated. Carrying out the hash using the same card at a later date (such as at the point of embarking or checking in for travel) enables a simple match to be performed for authentication that the card was used in the purchase transaction. This additional step beyond the payment process itself does not need to involve banks and other payment entities but can be used to authenticate the purchaser and payment mechanism.

For example, the payment may be for an airline ticket—by combining data from the purchaser's passport or similar identity document the airline ticket data can include a verifiable and authenticable record of presence of the passport (subject to re-presentation of the passport for creation of another hash for comparison).

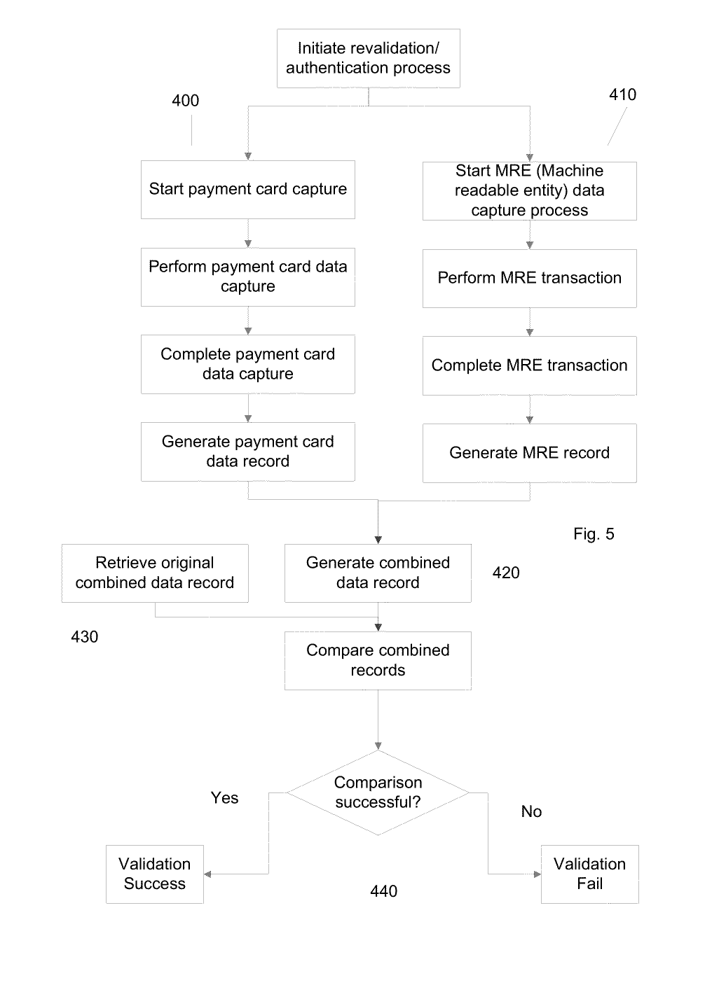

FIGS. 4 and 5 are flow diagrams of the data capture and validation process, respectively.

In FIG. 4, the payment process in a first strand 300 is illustrated as being performed in parallel to the capture of additional data (in this example MRE data in a second strand 310). While this is generally likely to be the case, it should be noted that this is an illustration only and does not reflect any specific timings between the two strands and there need not necessarily be any synchronisation between the two. Indeed, in embodiments in which a common RF transceiver is used for both payment and MRE data capture it will be appreciated that these two activities must happen with substantially non-overlapping timing given the same transceiver is reading two separate entities.

The data is collated at step 320 and stored as a collective record.

At a later time, the data may be validated by re-presentation of the payment card or device along with the object bearing the MRE data as is shown in FIG. 5. The process of FIG. 4 is repeated in first and second strands (400, 410), leading to a validation data record at step 420 that is then compared in step 430 against the original record (it will be appreciated that the date and timing information is not matched against the original) and validation success or failure reported in step 440.

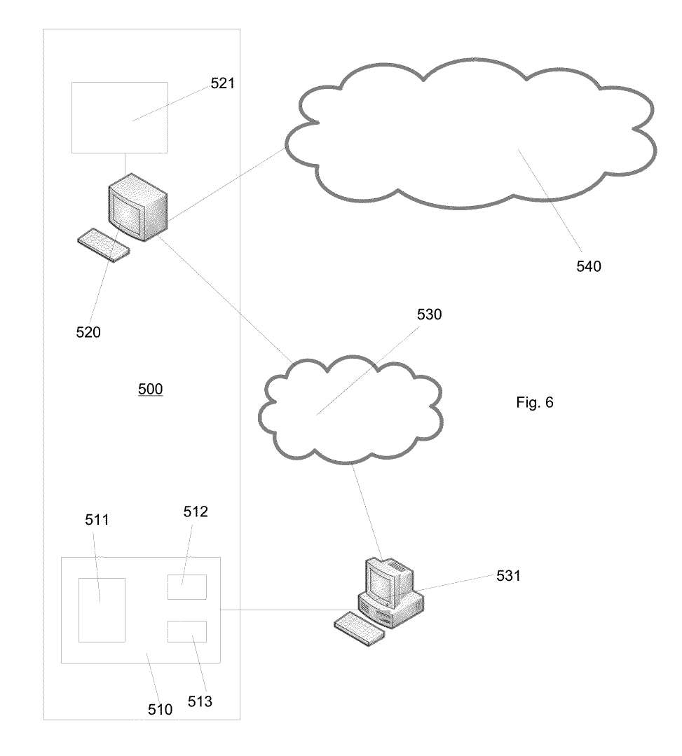

FIG. 6 is a schematic diagram of an increased security payment system according to another embodiment of the present invention.

The increased security payment system 500 includes a user payment device 510 and a payment processing system 520.

In the illustrated embodiment, the user payment device 510 includes a chip and PIN card reader 511 and a radio frequency transceiver 512. However, in alternate embodiments, other combinations of reader devices may be used and it may be that only a radio frequency transceiver is included in selected embodiments.

The user payment device 510 is connectable to a data communications network 530 via which it communicates with the payment processing system 520. In one embodiment, the user payment device is connectable to the data communications network 530 via a user's computer 531, for example via a USB connection. In another embodiment, the user payment device 520 is connectable to a data communications network via wireless communication such as WiFi, mobile telephone network or similar.

The user payment device 510 may be operated in a user's home or at another location remote of a point of purchase 540. Upon wishing to make a purchase, the user makes a payment via the chip and PIN card reader 511 by inserting a payment card and entering his or her PIN number. Increased security for the transaction is provided by associating the transaction with machine readable data retrieved using the radio frequency transceiver 512 in a manner described previously. For example, e-MRTD data may be read from a passport or similar by the radio frequency transceiver 512. In this embodiment, the e-MRTD data may be obtained and packaged with the payment data prior to submission to the payment processing system 520 for processing of payment or it may be requested during or after processing of payment by the payment processing system 520 (in which case it would be communicated separately (or communicated with a duplicate of) the payment data obtained from the chip and PIN card reader 511.

The increased security provisions may be applied as a default, at the user's choice or in response to a challenge from the payment processing system 520 or other entity in the payment or transaction chain.

The payment processing system 520 maintains records of the transaction and of the supplementary data such as e-MRTD data provided in a data repository 521. Payment data is typically communicated onwards to a credit/payment card processing network in a format common with payment data from other systems, retail establishments and the like. The payment data is, preferably, flagged (such as by virtue of data indicating it as originating from the payment processing system 521) to indicate that supplementary data has been recorded and it can be deemed more reliable/secure than a card not present transaction where card presence was not verified or even card present transactions without the supplementary data.

The nature of the supplementary data captured can optionally be verified by the payment processing system 520 (for example, e-MRTD bearing identity documents could be pre-registered by provision of a copy of a cryptographically signed hash which can be compared to that provided during a transaction).

In the case of documents requiring authorisation data in order to retrieve access keys, the authorisation data could be pre-registered with the user payment device 510. For example, the authorisation data could be written to a memory 513 such as a flash memory in the user payment device 510 so as to be available for use in accessing the e-MRTD data when presented to the user payment device 510. For example, the user payment device 510 memory 513 may be writeable while connected to the user's computer 531 (preferably subject to the provision of a password, certificate or the like authenticating the user to the user payment device 510). In another embodiment, the user payment device 510 may include a processor configured to execute a limited functionality web server via which the memory 513 can be written to/updated.

In one embodiment, the chip and PIN keypad is used by the user payment device 510 to control access to the authorisation data in the memory 513 with a pre-set PIN number (preferably different to that of the payment card) being required to enable access to the memory 513 following which the e-MRTD bearing document can be presented.

Should further levels of security and assurance be desired or required in respect of the payment, data from systems verifying origin or location of the user payment device 510 may also be included in the communication to the payment processing system 520. Examples of systems are described in the applicant's co-pending patent applications Nos. WO2001/91073, WO2011/015885, and/or WO2011/148168, the contents of which are herein incorporated by reference.

It is to be appreciated that certain embodiments of the invention as discussed above may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

The contents of GB1209232.6, from which this application claims priority, and of the abstract accompanying this application are herewith incorporated by reference.

1. A card payment unit including a payment card reader, a secondary reader and a controller, the controller being configured to operate the payment card reader to participate in a payment communication to obtain payment data, the controller being further configured to operate the secondary reader to obtain supplementary data from a machine readable entity that is physically proximate to the unit, the supplementary data being obtained via a communication that is separate from the payment communication, the controller being configured to generate a payment record from said payment data and said supplementary data.

2. A card payment unit as claimed in claim 1, wherein the payment card reader includes chip and PIN payment card reader.

3. A card payment unit as claimed in claim 1, wherein the secondary reader is a Radio Frequency, RF, transceiver configured to communicate with the machine readable entity via RF to obtain at least some of the supplementary data.

4. A card payment unit as claimed in claim 3, wherein the payment card reader includes an RF transceiver configured to communicate with an RF type payment card to obtain at least some of the payment data.

5. A card payment unit as claimed in claim 4, wherein the RF type payment card may be a debit card, a credit card, an RFID card or a near field communications device configured to act as a payment card.

6. A card payment unit as claimed in claim 4, comprising a common RF transceiver configured to provide RF communication functions to the payment card reader and the secondary reader.

7. A card payment unit as claimed in claim 6, wherein the payment card reader and the secondary reader comprise the controller and common RF transceiver operating in different modes, a first mode configured to obtain payment data from a payment card and the second mode configured to obtain the supplementary data.

8. A card payment unit as claimed in claim 1, further comprising an input device configured to receive authentication data on the machine readable entity, the controller being configured to operate the secondary reader to obtain supplementary data in dependence on the authentication data.

9. A card payment unit as claimed in claim 8, wherein the input device is selected from the set including a keyboard, keypad, camera, barcode reader or optical character recognition device.

10. A card payment unit as claimed in claim 8, wherein the input device is configured to read the authentication data from the machine readable entity.

11. A card payment unit as claimed in claim 9, wherein the controller is configured to generate data for the supplementary data by decoding data obtained by the secondary reader using the authentication data.

12. A card payment unit comprising:
a first payment module including a radio frequency transceiver configured to participate in a payment communication with an RF payment token to obtain payment data;
a second payment module including a contact card reader configured to perform a contact read of a payment token to obtain payment data;
a supplementary module configured to operate the radio frequency transceiver to obtain supplementary data resulting from an RF communication with a machine readable entity that is physically proximate to the unit; and,
a controller configured to receive payment data from one of the first and second payment modules and configured to combine at least a subset of the payment data and the supplementary data to generate a payment record.

13. A card payment method comprising:
receiving a payment via a card payment reader and generating payment data;
operating, in a separate operation to the card payment, the card payment reader to obtain supplementary data from a machine readable entity physically proximate to the card payment reader; and
generating a payment record in dependence on the payment data and supplementary data.

14. A card payment method as claimed in claim 13, wherein the card payment reader includes a radio frequency transceiver, the supplementary data being obtained via an RF communication with the machine readable entity.

15. A card payment method as claimed in claim 14, wherein the payment comprises a contactless payment performed in an RF communication with the RF transceiver.

16. A card payment method as claimed in claim 13, further comprising subsequently operating the card payment reader to obtain further supplementary data from the machine readable entity physically proximate to the card payment reader; and validating the payment record in dependence on the further supplementary data.

17. An increased security payment system comprising a user payment device and a remote payment processing system, the user payment device including a payment card reader and a radio frequency transceiver and being connectable to a data communications network for communication with the payment processing system, wherein the user payment device is arranged, during a payment made via the payment card reader, to operate the radio frequency transceiver to obtain supplementary data from a machine readable entity that is physically proximate to the user payment device and to communicate data on the payment and on the supplementary data via the data communications network to the payment processing system, the payment processing system being arranged to process the received data and communicate data on the payment to a card payment processing network to cause completion of the payment.

18. An increased security payment system as claimed in claim 17, wherein the user payment device includes a memory for encoding authorisation data, the user payment device being arranged to access the authorisation data in the memory for accessing the machine readable entity when obtaining the supplementary data.

19. An increased security payment system as claimed in claim 17, wherein the data on the payment is communicated to the remote payment processing system prior to obtaining supplementary data, the remote payment processing system being arranged to process the payment data and communicate a challenge to the user payment device under predetermined conditions, the user payment device being arranged, in response to receipt of the challenge, to operate the radio frequency transceiver to obtain the supplementary data and to communicate data on the supplementary data to the payment processing system.

20. An increased security payment system as claimed in claim 17, wherein the remote payment processing system is arranged to verify the received data on the supplementary data.
